(19) United States
(12) Patent Application Publication
(10) Pub. No.: US 2022/0157060 A1
(43) Pub. Date: May 19, 2022

(54) MULTI-TOD SURROUND CAMERA DEVICE FOR DETECTING DRONE INTRUSION, AND DRONE INTRUSION DETECTION AND CAPTURE METHOD USING SAME

(71) Applicant: TELME ELECTRONICS CO., LTD., Anyang-si (KR)

(72) Inventor: Woong Do PARK, Anyang-si (KR)

(21) Appl. No.: 17/432,963

(22) PCT Filed: Jan. 29, 2020
(86) PCT No.: PCT/KR2020/001350

§ 371 Date: Aug. 23, 2021

(30) Foreign Application Priority Data
Feb. 27, 2019 (KR) 10-2019-0022895
Feb. 27, 2019 (KR) 10-2019-0022896

(51) Int. Cl. G06V 20/52; G06V 20/00; G08G 5/00

(52) U.S. Cl. CPC G06V 20/52; G08G 5/006; G06V 20/35

(57) ABSTRACT

A multi-TOD surround camera device according to an embodiment of the present invention is directed to a multi-TOD surround camera device for detecting a drone intruding into a no-fly zone, the multi-TOD surround camera device being capable of rapidly detecting a drone intruding into a no-fly zone even at night or in bad weather, the multi-TOD surround camera device including: a high-performance TOD camera configured to photograph an upper space during the nighttime; a daytime camera configured to photograph the upper space during the daytime; an LED light projector configured to radiate search light at night; and a plurality of TOD cameras configured to photograph a surrounding 360-degree space.

### TECHNICAL FIELD

The present invention relates to a device and method that detect a drone, i.e., an unmanned aerial vehicle, intruding into a no-fly zone, and provides a drone intrusion detection device and method that are characterized in that they detect the intrusion of a drone immediately by identifying the location of the drone, photographed by a surround method through a thermal imaging device (TOD), in real time through a space map.

### BACKGROUND ART

In general, drones refer to airplanes or helicopter-shaped vehicles on which a person does not ride and which fly through the guidance of radio waves.

In the early days, drones were used as targets instead of enemy planes for the purpose of the practice firing of air force aircraft, anti-aircraft guns, and missiles. Gradually, with the development of wireless technology, reconnaissance aircraft were developed, and they were also used for intruding deep into enemy's territory and performing reconnaissance and surveillance. In recent years, drones are also mounted with various weapons such as missiles and used as attack aircraft.

In accordance with the purposes of use of drones, a variety of aircraft with various sizes and various types of performance are being developed. In addition to large aircraft having a military use, micro-drones are being actively developed and researched. In addition, drones have been developed and commercialized as personal hobbies. Drones are deployed and operated in areas inaccessible to humans, such as jungles, remote areas, volcanic areas, natural disaster areas, and accident areas.

However, as the range of use of drones is gradually expanding, the number of drones that intrude into no-fly areas such as airports and nuclear power plants is increasing. The resulting chaos and economic loss are becoming social issues.

Therefore, the number of places where systems for detecting drones intruding into a no-fly zone are installed and operated is increasing. However, in reality, it is difficult to detect a drone at night or in bad weather, and it is also difficult to immediately capture an intruding drone, move it to a safe place, and then destroy it.

### DISCLOSURE

### Technical Problem

The present invention intends to provide a space map that may constantly monitor the intrusion of a drone into a no-fly zone such as an airport or a nuclear power plant.

The present invention intends to provide a device and method that may precisely monitor the intrusion of a drone even in a period during which it is difficult to secure a field of view of a surveillance camera, such as at night or in bad weather.

In addition, the present invention intends to provide a system that may rapidly and safely capture a drone intruding into a no-fly zone and guide it to a safe area.

### Technical Solution

The drone intrusion detection device of the present invention includes a TOD camera module capable of photographing a drone with high performance without degradation in performance despite daytime, nighttime and changes in weather conditions.

The drone intrusion detection device of the present invention includes an integrated control device capable of rapidly detecting an unmanned drone intruding into a no-fly zone and controlling the capture thereof while simultaneously monitoring an actual image screen and a 3D space map image screen.

In addition, the present invention is provided with a device that captures an intruding drone as rapidly as possible, and guides it to a safe area, and then destroys it.

### Advantageous Effects

The drone intrusion detection and capture system according to the present invention may acquire an image by photographing a drone with high performance without deterioration in performance even at night and in a bad weather period having poor weather conditions.

The drone intrusion detection and capture system according to the present invention may rapidly control an intruding drone by identifying integrated information acquired from a drone displayed on a real drone image and a 3D space map in real time.

When an external drone equipped with an explosive intrudes into a national facility, the present invention makes it possible to rapidly subdue the external drone, guide it to a safe area, and then destroy it.

### DESCRIPTION OF DRAWINGS

FIG. 1 is a diagram showing a no-fly zone for drones according to the present invention;

FIG. 2 is a perspective view of a multi-TOD surround camera device for capturing a drone according to the present invention;

FIG. 3 is a plan view of the multi-TOD surround camera device for capturing a drone according to the present invention;

FIG. 4 is a side view of the multi-TOD surround camera device for capturing a drone according to the present invention;

FIG. 5 is an embodiment of a multi-TOD surround camera device for capturing a drone according to the present invention;

FIG. 6 is a conceptual diagram showing an overall protection range acquired by the cooperation of the multi-TOD surround camera device for capturing a drone according to the present invention;

FIG. 7 shows an embodiment in which a drone intrusion space setting map according to the present invention is formed on a plane;

FIG. 8 shows an embodiment in which a drone intrusion space setting map according to the present invention is formed in a space;

FIG. 9 shows an embodiment in which a drone is detected using a drone intrusion space setting map according to the present invention;

FIG. 10 is a flowchart showing a process of forming a space setting map according to the present invention; and

FIG. 11 is an embodiment showing the detection and capture of the intrusion of a drone according to the present invention.

### MODE FOR INVENTION

The present invention may be subject to various modifications and have various embodiments. Specific embodiments will be illustrated in the drawings and described in detail.

However, this is not intended to limit the present invention to specific embodiments, but should be understood as encompassing all modifications, equivalents and substitutes included in the spirit and technical scope of the present invention. In the description of each figure, like reference numerals have been used for like components.

The terms used in the present application are used merely to describe specific embodiments, and are not intended to limit the present invention. A singular expression includes a plural expression unless the context clearly dictates otherwise. In the present application, it should be understood that terms such as “include” or “have” are intended to designate a feature, a number, a step, an operation, a component, a part, or a combination thereof described in the specification as being present, but do not preclude the possibility of the presence or addition of one or more other features, numbers, steps, operations, components, parts, or combinations thereof.

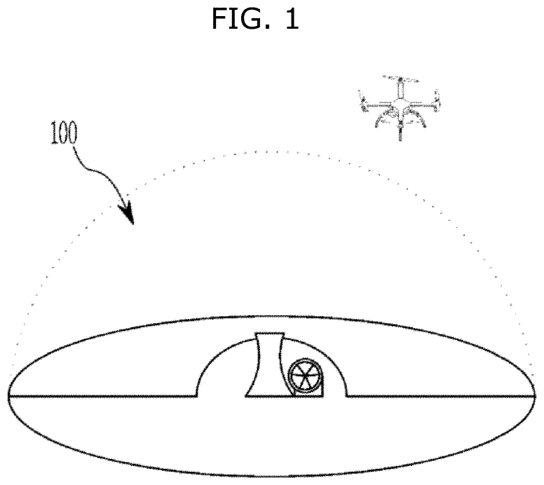

FIG. 1 is a conceptual diagram showing a general no-fly zone for drones.

Since major national facilities, such as the nuclear power plant of FIG. 1, may suffer damage due to the intrusion of drones and the throwing of explosives, a no-fly zone is set for the ground and air within a radius of several kilometers. Furthermore, there is needed a system that immediately detects, alerts, and controls a drone invading into this set area, moves it to a safe area, and then destroys it.

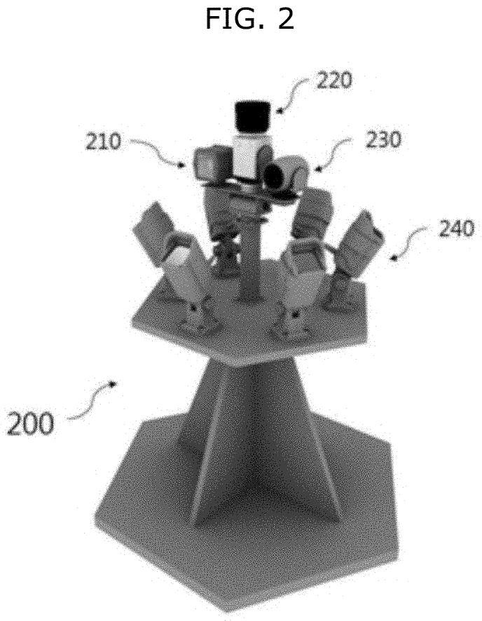

FIG. 2 is a multi-TOD surround camera device 200 according to the present invention.

The device includes a plurality of TOD cameras, an LED light projector, and a daytime camera.

The plurality of TOD cameras capable of photographing images of a surrounding 360-degree area is installed on a hexagonal fixing plate formed on the top end of the pedestal base of the device, a circular support is formed at the center of the fixing plate, and the high-performance TOD camera, the LED light projector, and the daytime camera are installed on the top of the circular support.

Preferably, the number of the plurality of TOD cameras and the shapes of the hexagonal fixing plate and the circular support are not limited to those shown in the embodiment of FIG. 2, and may be modified to suit the practice of the invention below.

The daytime camera 210 provides the color image information of the upper part of a building during the daytime, and the high-performance TOD camera 220 is intended to provide the spatial image information of the upper part of the building during the nighttime and has a zoom function.

The LED light projector 230 has a search light function that radiates light during the nighttime, thereby providing lighting so that a drone intruding into the no-fly zone can be clearly photographed.

The device is provided with the plurality of TOD cameras 240, and the plurality of TOD cameras equally divides a space of 360 degrees forward, backward, left, and right, photographs respective areas, and provides image information.

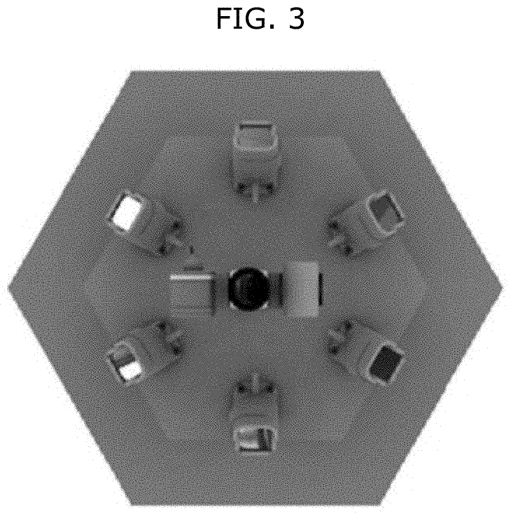

FIG. 3 is a plan view of the multi-TOD surround camera device 200, from which it can be seen that the plurality of TOD cameras 240 is arranged in directions of 360 degrees and the high-performance TOD camera 220 is directed in an upward direction.

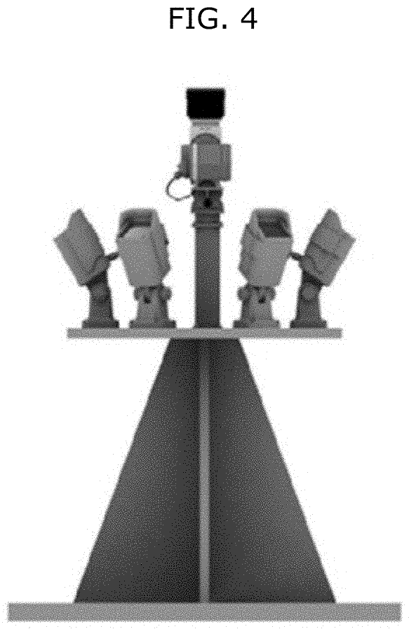

FIG. 4 is a side view of the multi-TOD surround camera device 200.

The plurality of TOD cameras 240 installed on the side in six directions will photograph a space over about 60 degrees from the ground, and the upper space above the 60 degrees that cannot be photographed with the plurality of TOD cameras is photographed with the high-performance TOD camera 220.

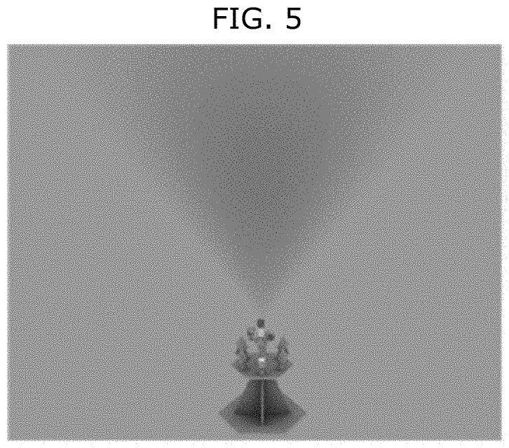

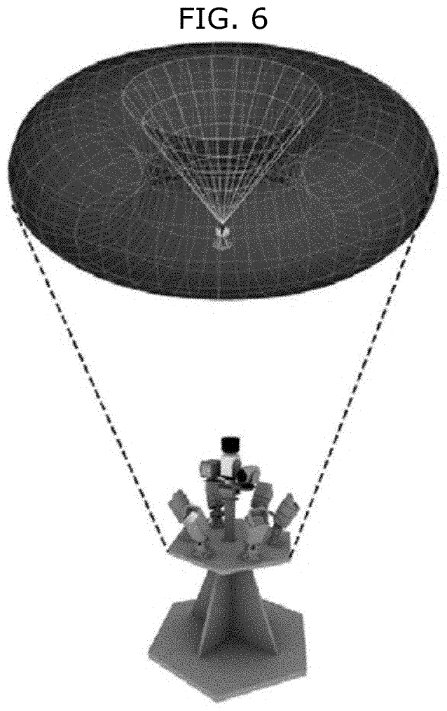

FIGS. 5 and 6 are conceptual views illustrating a range monitored by the multi-TOD surround camera device 200.

An intruding drone is monitored by the plurality of TOD cameras in the side part over about 60 degrees from the ground, and is monitored by the high-performance TOD camera in the top part above 60 degrees.

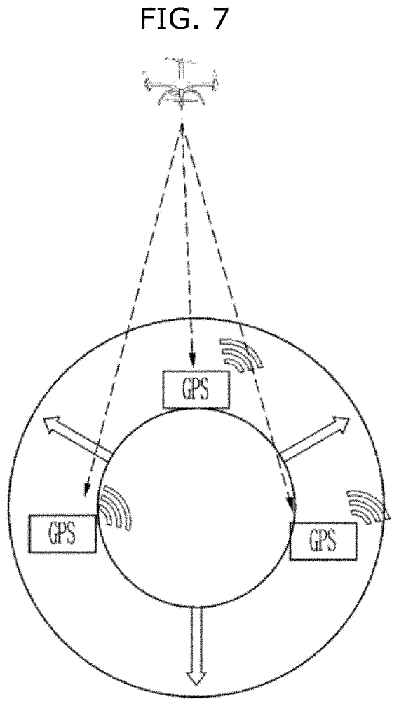

FIG. 7 shows an embodiment in which a drone intrusion space setting map according to the present invention is formed on a plane.

A space setting map is a space that is formed by virtual lines and designed to identify the exact location of a drone intruding into the no-fly zone within a drone intrusion detection system. Every point in the virtual space may be specified by a GPS location value, a distance value from a TOD camera, a pixel coordinate value on an image screen, and a zoom value of a camera.

In other words, when the four types of values for the virtual space for the no-fly zone are stored in the system in advance, the actual GPS location and distance values of the intruding drone are determined from a pixel coordinate value on a video screen and the zoom value of the camera.

A process of forming a space setting map on a plane is performed as follows:

First, a GPS location value and a distance value are measured while gradually expanding a target area from a range closest to the TOD camera to the periphery.

All GPS location values for respective points shown on a camera image screen are received and stored while moving left or right on a circle corresponding to the minimum distance from the TOD camera device,.

After storing all the GPS location values, errors between the previously held actual measurement values and the received GPS location values are corrected.

When the storage of the GPS location values for the minimum distance and the error correction are completed, a movement is made toward the periphery by a basic spacing distance and the previous process is repeated.

The spacing distance may be adjusted to a value in the range from a few meters to tens of meters. In this case, the distance value may be measured with a laser range finder (LRF).

The GPS location values obtained above are matched with the camera photographed image information and then stored. The image information may include a pixel coordinate value on an image screen and a camera zoom value. The errors are corrected for all measured values and stored using a correction value used to correct the error of the GPS location value measured with respect to the minimum distance.

When the above process is completed up to the outermost location of the no-fly zone, the collection of information about the ground part is terminated and a movement is made to the upper space.

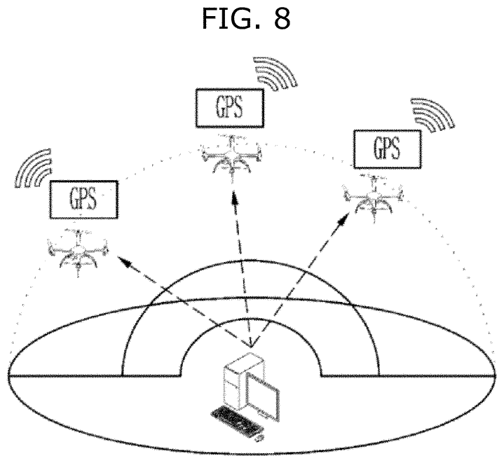

FIG. 8 shows an embodiment in which a drone intrusion space setting map according to the present invention is formed in an upper space.

The upper space requires a drone for collecting information, and the drone for collecting information is equipped with a GPS receiver and thus collects GPS location information at each point.

Furthermore, the distance to the drone for collecting information is measured using an LRF.

A plurality of such drones for collecting information is used while a target area is gradually expanded from the nearest distance to the outermost range of the no-fly zone.

At the same time, the distance to the drone at each point, a photographed image, display pixel information, and camera zoom information are stored as a set.

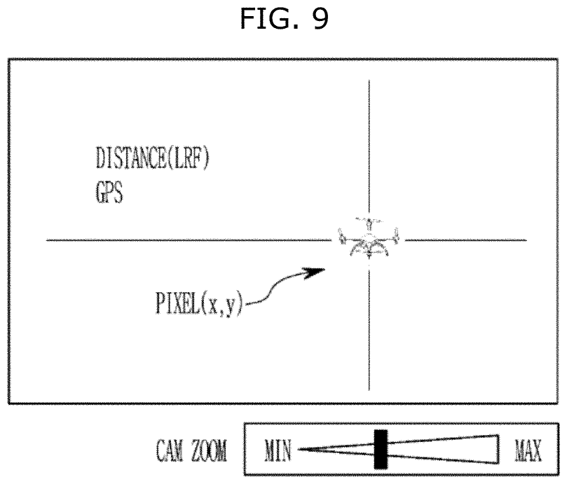

FIG. 9 shows an embodiment in which an intruding drone is detected based on an image photographed by a camera and information stored in a system.

Based on the corrected GPS coordinates, a virtual line may be set up to the maximum distance collected during environmental setting. Not only the pixel information of the interesting virtual line from an output image and camera zoom information but also the distance value by the LRF and the GPS location value are all matched with one another and then displayed. An emergency is alerted.

Preferably, a capture drone is always flown at a specific location on the virtual line. When a drone intrudes from the outside, the GPS location value and the distance-related coordinate information are transmitted from the system to the capture drone in real time.

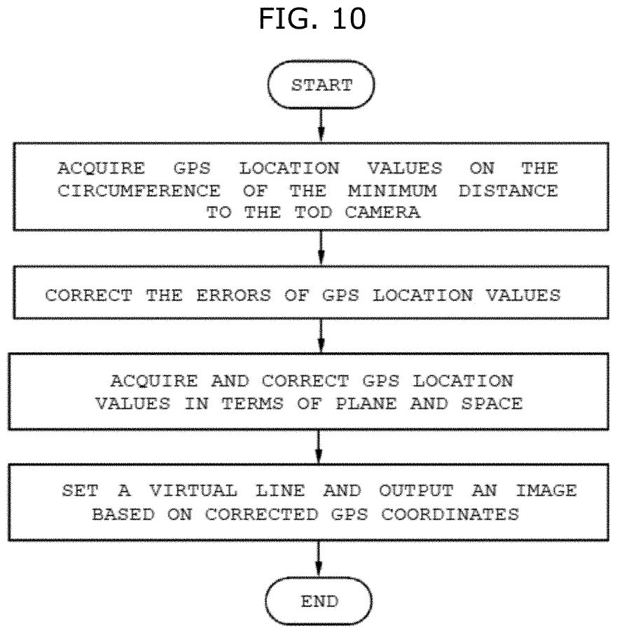

FIG. 10 is a flowchart summarizing the process of forming a space setting map according to the present invention disclosed in FIGS. 7 to 9.

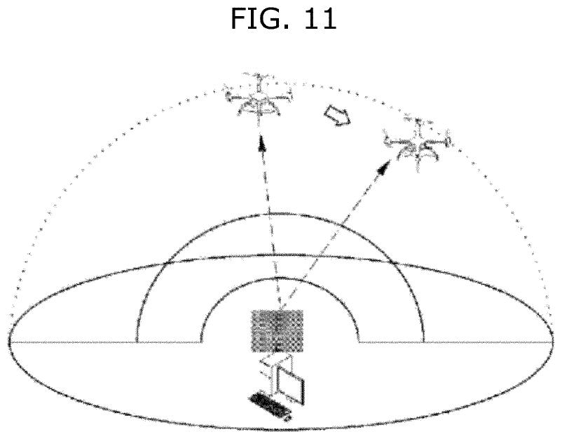

FIG. 11 is an embodiment showing the detection and capture of the intrusion of a drone according to the present invention.

The multi-TOD surround camera device according to the present invention detects the intrusion of a drone even at night or in bad weather, and delivers GPS location information, stored as the pixel and zoom information set of a photographed drone image, to the capture drone.

In this case, the capture drone for an upper part may track an intruding drone, and the location of the intruding drone may be continuously and clearly identified through the search light attached to the multi-TOD surround camera device.

Thereafter, the capture drone captures an intruding drone by firing a net from a location close to the intruding drone, and then transports the captured drone to an external safe area and isolates it from the no-fly zone.

Thereafter, it is detected whether an explosive is installed on the isolated drone. If an explosive is installed, it is destroyed after being dismantled.

### INDUSTRIAL APPLICABILITY

The drone intrusion detection and capture system according to the present invention may acquire an image by photographing a drone with high performance without deterioration in performance even at night and in a bad weather period having poor weather conditions.

The drone intrusion detection and capture system according to the present invention may rapidly control an intruding drone by identifying integrated information acquired from a drone displayed on a real drone image and a 3D space map in real time.

When an external drone equipped with an explosive intrudes into a national facility, the present invention makes it possible to rapidly subdue the external drone, guide it to a safe area, and then destroy it. First Named Inventor: PARK, Woong Do

1. A multi-TOD surround camera device for detecting a drone intruding into a no-fly zone, the multi-TOD surround camera device being capable of rapidly detecting a drone intruding into a no-fly zone even at night or in bad weather, the multi-TOD surround camera device comprising:
a high-performance TOD camera configured to photograph an upper space during a nighttime;
a daytime camera configured to photograph the upper space during a daytime;
an LED light projector configured to radiate search light at night; and
a plurality of TOD cameras configured to photograph a surrounding 360-degree space.

2. The multi-TOD surround camera device of claim 1, wherein the plurality of TOD cameras is installed on a fixing plate formed at a top end of a pedestal base of the device.

3. The multi-TOD surround camera device of claim 2, wherein a circular support is formed at a center of the fixing plate, and the high-performance TOD camera, the LED light projector, and the daytime camera are installed on a top portion of the support.

4. The multi-TOD surround camera device of claim 2, wherein the plurality of TOD cameras:
divides and photographs a space of 360 degrees in a horizontal direction;
photographs a space over 60 degrees from a ground in a vertical direction; and
detects the spaces.

5. The multi-TOD surround camera device of claim 4, wherein the high-performance TOD camera photographs and detects the upper space above the 60 degrees that cannot be photographed with the plurality of TOD cameras.

6. A drone intrusion detection and capture method using a multi-TOD surround camera device, the drone intrusion detection and capture method being a method for detecting and capturing a drone intruding into a no-fly zone and being capable of rapidly detecting and capturing a drone intruding into a no-fly zone even at night or in bad weather, the drone intrusion detection and capture method comprising:
collecting and storing information on a ground part necessary for formation of a space setting map while moving from a maximum proximity range to a periphery on a ground within a no-fly zone;
collecting and storing information about an upper space necessary for the formation of the space setting map by using a plurality of information collection drones each equipped with a GPS receiver in the no-fly zone;
detecting a drone, intruding from an outside, with a multi-TOD surround camera device in real time;
delivering GPS location information of the external intruding drone to a capture drone; and
capturing, by the capture drone, the intruding drone, transporting, by the capture drone, the intruding drone to a safe area, and then destroying, by the capture drone, the intruding drone.

7. The drone intrusion detection and capture method of claim 6, wherein the multi-TOD surround camera device comprises:
a high-performance TOD camera configured to photograph an upper space during a nighttime;
a daytime camera configured to photograph the upper space during a daytime;
an LED light projector configured to radiate search light at night; and
a plurality of TOD cameras configured to photograph a surrounding 360-degree space.

8. The drone intrusion detection and capture method of claim 6, wherein collecting and storing the information on the ground part comprises:
positioning a plurality of GPS receivers;
storing GPS location information of each point and distance information measured with a laser range finder (LRF); and
collecting information at spacing intervals in a range from a few meters to tens of meters.

9. The drone intrusion detection and capture method of claim 6, wherein collecting and storing the information about the upper space comprises storing GPS location information and distance information measured with a laser range finder (LRF) while the plurality of information collection drones moves from a maximum proximity distance to an outermost range.

10. The drone intrusion detection and capture method of claim 8 any one of claims 8 and 9, wherein the stored GPS location information and distance information are stored as a set along with display pixel information and camera zoom information regarding a photographed image, and the GPS location information stored as the set along with the display pixel and zoom information of the image photographed for the intruding drone is delivered to the capture drone.

11. The drone intrusion detection and capture method of claim 9, wherein the stored GPS location information and distance information are stored as a set along with display pixel information and camera zoom information regarding a photographed image, and the GPS location information stored as the set along with the display pixel and zoom information of the image photographed for the intruding drone is delivered to the capture drone.
